(19) United States
(12) Patent Application Publication
(10) Pub. No.: US 2008/0109710 A1
(43) Pub. Date: May 8, 2008

(54) Viterbi decoding method

(75) Inventor: Mitsunori Takanashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/980,658

(22) Filed: Oct. 31, 2007

(30) Foreign Application Priority Data
Nov. 2, 2006 (JP) 298621/2006

(51) Int. Cl. G06F 11/07

(52) U.S. Cl. 714/799; 714/E11.024

(57) ABSTRACT

A decoding method relative to this application improves an error correction performance without increasing a memory. The decoding method includes obtaining a first decoded result from a first decoding path being on a trellis diagram; determining whether the first decoded result is incorrect or not; creating a second decoding path when the first decoded result is incorrect; and obtaining a second decoded result from the second decoding path.

### BACKGROUND OF THE INVENTION

1. Field of the Invention

The present invention relates to a decoding method of an error correction code which is used in a W-CDMA (wideband code division multiple access) communication.

2. Description of Related Art

Viterbi decoding is a decoding method for a convolution code, which has been known as one of the most general error correcting methods. The Viterbi decoding is the maximum likelihood decoding method, and the transition of the likelihood state is traced back to obtain a decoding result. Whether the decoding result is correct, or not, is determined by using an error detecting method such as CRC (cyclic redundancy check), and when the decoding result is in error, the retransmission of data is requested.

JP 07-288478 A discloses a conventional art in which the error correction performance of the above Viterbi decoding is improved. As shown in FIG. 28, a Viterbi decoding device 101 disclosed in JP 07-288478 A includes a metric computational circuit 102, an ACS (add compare select) circuit 103, a path select memory circuit 104, a path metric memory circuit 105, a multiple trace back circuit 106, and a stack memory 107. The likelihoods (metrics) of the respective partial paths are calculated from a received data string in the metric computational circuit 102.

Subsequently, in the ACS circuit 103, the metrics of the plural paths that transit to the respective states at the respective times are compared with each other. Then, not only a path that is highest in the metric is selected, and a path select signal is stored, but also metric differences from other paths are stored at the same time, in the path select memory circuit 104. Also, the path metric is stored and updated in the path metric memory circuit 105 as with the normal Viterbi signal. Then, the trace back is conducted by the multiple trace back circuit 106 and the stack memory 107 on the basis of information in the path select memory circuit 104. In this case, the number of survivor paths is not limited to one depending on the given permissible metric difference, but plural paths remain by plural times of trace back.

The operation of the decoding device 101 will be described. FIGS. 29 and 30 are flowcharts showing a decoding method disclosed in JP 07-288478 A. As shown in FIG. 29, the stack memory, the stack memory address, the permissible metric difference, the trace back (TB) branch number counter, the TB counter, and the state are first initialized in an initializing process (Step S110). Then, a time tn is initialized (Step S111), and the trace back process is then conducted. The path select signal and the metric difference in that state are read from the path select memory circuit (Step S112), and compared with the permissible select difference (Step S113). In the case where the metric difference is equal to or lower than the permissible metric difference, the metric difference is stored in the stack memory (Step S114), and the address is updated (Step S115).

Then, after a state before one time is calculated (Step S116), and the decoded data is calculated and stored (Step S117), the time is changed (Step S118), and it is determined whether the time is further traced back, or not (Step S119). Now, in the case where it is determined that one trace back has been completed, it is determined whether the information has been stored in the stack memory, or not (Step S120). In the case where the information has not been stored in the stack memory, the processing is terminated (Step S129). Also, in the case where the information has been stored in the stack memory, the branch flag of one information item of the most significant (an address that has been finally stored) is determined as shown in FIG. 30 (Step S121). In the case where the branch flag is “1”, one information of the most significant address is erased, and the address is decremented by 1(Step S130). Then, the operation is again returned to Step S120. On the other hand, in the case where the branch flag is “0”, another parameter of the one information is read, and the branch flag is converted from 0 to 1 with the remaining metric value as the permissible metric difference (Step S122). Thereafter, the updated one information is again stored in the stack memory (Step S123).

Then, the cumulative value of the number of branches to be traced back (TB) is calculated (Step S124). In the case where the cumulative value is equal to or lower than a limit value, the TB counter counts up (Step S126), and the decoded data up to a branch point is copied from the previous decoded data (Step S127), and the path select signal in the state of the branch point is reversed (Step S128). Thereafter, the operation is returned to Step S116, and the trace back is conducted. On the other hand, in the case where the cumulative value exceeds the limit value, it is determined that the processing is short, and the decoding process is terminated (Step S129).

That is, in the Viterbi decoding device 101, in the case where the survivor paths in the respective states are selected in the ACS calculation, not only only one path that is highest in the likelihood is selected, and its path select signal is stored, but also the likelihood differences between the path that is highest in the likelihood and other paths are also stored therein together. Then, in the case where the decoded data is obtained by the trace back, the multiple trace back is conducted in which not only the decoding path having the highest likelihood but also the paths that are equal to or lower than the permissible metric difference which is a predetermined set threshold value in the likelihood of the trace back section of the highest likelihood path are traced back, respectively, to obtain plural decoding path candidates.

Then, in the case where the multiple trace back is conducted, the plural candidates are searched by a recursive method, and the permissible metric difference is the likelihood difference that has been stored in that state are compared with each other in the respective states that are traced back in this situation. In the case where the likelihood difference is equal to lower than the permissible metric difference, the plural branches can be selected. A branch flag indicating a time of that state, the state, and which branch is selected to conduct the trace back, and a value resulting from subtracting the likelihood difference from the permissible metric difference are stored in the stack memory.

When decoding is conducted by the recursive method, in the subsequent trace back, the decoding results of the common partial paths among the decoded data of the paths that have passed by the previous trace back are used as a copy, the different partial paths are newly analyzed from the time and the state which have been stored in the stack memory, and only the path select signal at the branch point is reversed to conduct the trace back. As a result, since the decoded data of the remaining partial paths is obtained, the processing time can be reduced when the plural paths are set as the survivor paths in the Viterbi decoding to obtain the plural decoded data candidates. In this way, the plural survivor paths that are high in the likelihood in each of the states are saved, and the plural times of trace back is conducted, to thereby increase the possibility that decoding is correctly conducted. Also, there is cited JP 06-284018 A as a technique related to JP 07-288478 A.

### SUMMARY

However, We have now discovered that in the method disclosed in JP 07-288478 A, the plural paths having the likelihood difference that is equal to or lower than a certain threshold value are saved, and all of the decoding results of those plural paths must be saved. In addition, because what is the time point (time), what is the state of the path, and what is the likelihood difference of the path must be saved, there arises such a problem that a large quantity of memory that saves the decoded data is required as compared with the normal Viterbi decoding device.

According to one aspect of the present invention, a decoding method includes obtaining a first decoded result from a first decoding path being on a trellis diagram; determining whether the first decoded result is incorrect or not; creating a second decoding path when the first decoded result is incorrect; and obtaining a second decoded result from the second decoding path.

According to the present invention, there can be provided the Viterbi decoding method that improves the error correction performance without increasing the memory.

These and other objects and many of the attendant advantages of the invention will be readily appreciated as the same becomes better understood by reference to the following detailed description when considered in connection with the accompanying drawings.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing a convolutional coder;

FIG. 2 is a diagram showing a state transition of the convolutional coder;

FIG. 3 is a diagram showing a transition state when values indicated in Table 1 are inputted;

FIG. 4 is a diagram showing a trellis diagram when the values indicated in Table 1 are inputted;

FIG. 5A and FIG. 5B are diagrams showing convolutional coders that are used in a W-CDMA communication;

FIG. 6 is a block diagram showing a Viterbi decoding device according to an embodiment of the present invention;

FIG. 7 is a diagram showing an ACS when a state transits from a certain time point t to t+1;

FIG. 8 is a diagram showing the results that are stored in an ACS result storage section in the Viterbi decoding device according to the embodiment of the present invention;

FIG. 9 is a diagram showing survivor paths (ACS results) on the trellis diagram shown in FIG. 4;

FIG. 10 is a diagram showing the results in the case of decoding a first candidate that is stored in the ACS result storage section in the Viterbi decoding device according to the embodiment of the present invention;

FIG. 11 is a diagram showing a decoding path (first decoding path) of the first candidate in the trellis diagram;

FIG. 12 is a diagram showing a trellis diagram in the case where “0” of 2 bits is inserted as tail bits at the end of input data to be input to the coder;

FIG. 13 is a diagram showing the survivor paths (ACS results) in the trellis diagram shown in FIG. 4 together with the ACS results;

FIG. 14 is a diagram showing a decoder for obtaining the decoded data from the ACS results;

FIG. 15 is a diagram showing a decoding path (second decoding path) of a second candidate in the trellis diagram;

FIG. 16 is a diagram showing the ACS results of the ACS result storage section in the case of selecting the second decoding path of the second candidate;

FIG. 17 is a diagram showing the ACS results of the ACS result storage section in the case of selecting a decoding path of a third candidate;

FIG. 18 is a diagram showing the decoding path of the third candidate in the trellis diagram;

FIG. 19 is a diagram showing a condition where bit inversion is conducted after the ACS results are read from the ACS result storage section;

FIG. 20 is a diagram showing only the survivor paths that are extracted from the trellis diagram shown in FIG. 12;

FIG. 21 is a flowchart showing a Viterbi decoding method according to the embodiment of the present invention;

FIG. 22 is a diagram showing first to fourth candidates in the trellis diagram of the convolutional coder of a constraint length;

FIG. 23 is a graph showing the results obtained by the Viterbi decoding method according to the embodiment of the present invention as compared with the general Viterbi decoding device (conventional art) that terminates the decoding with the first candidate;

FIG. 24 is a graph showing the results obtained by the Viterbi decoding method according to the embodiment of the present invention as compared with the general Viterbi decoding device (conventional art) that terminates the decoding with the first candidate;

FIG. 25 is a graph showing the results obtained by the Viterbi decoding method according to the embodiment of the present invention as compared with the general Viterbi decoding device (conventional art) that terminates the decoding with the first candidate;

FIG. 26A and FIG. 26B are diagrams for explaining the advantages of the present invention, in which FIG. 26A is a diagram showing the decoding results in the case where noises are small, and FIG. 26B is a diagram showing the decoding results in the case where noises are large;

FIG. 27 is a diagram showing the decoding paths of the first candidate to the third candidate in the trellis diagram in the case where the tail bits are not inserted;

FIG. 28 is a block diagram showing a Viterbi decoding device disclosed in JP 07-288478 A;

FIG. 29 is a flowchart showing a Viterbi decoding method disclosed in JP 07-288478 A; and

FIG. 30 is a flowchart showing the Viterbi decoding method disclosed in JP 07-288478 A, which shows steps subsequent to steps shown in FIG. 29.

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes. Now, a description will be given in more detail of specific embodiments of the present invention with reference to the accompanying drawings. In general, a Viterbi decoding method is a maximum likelihood decoding method, which traces back the transition of the likelihood state to obtain the decoding results. It is determined whether the decoding results are correct, or not, by using an error detecting method such as a CRC, and when an error is detected, the retransmission of data is requested. On the contrary, in this embodiment, in the case where the error determination is conducted in the Viterbi decoding, the transition is changed to again conduct trace back, thereby again obtaining the decoding results. This operation is repeated until the error determination is accepted or reaches a specific number of times. The above operation makes it possible to increase the possibility that the decoding can be conducted. Further, in this embodiment, no specific memory is required, and an increase in logic can be suppressed to a minor amount.

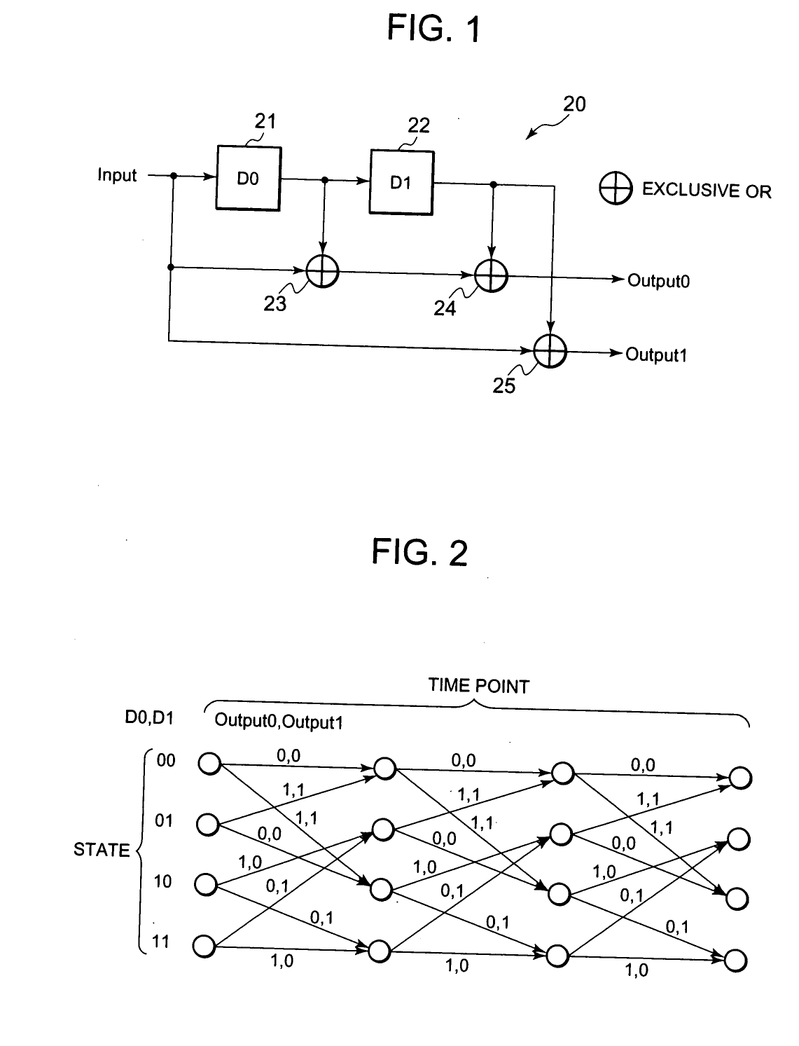

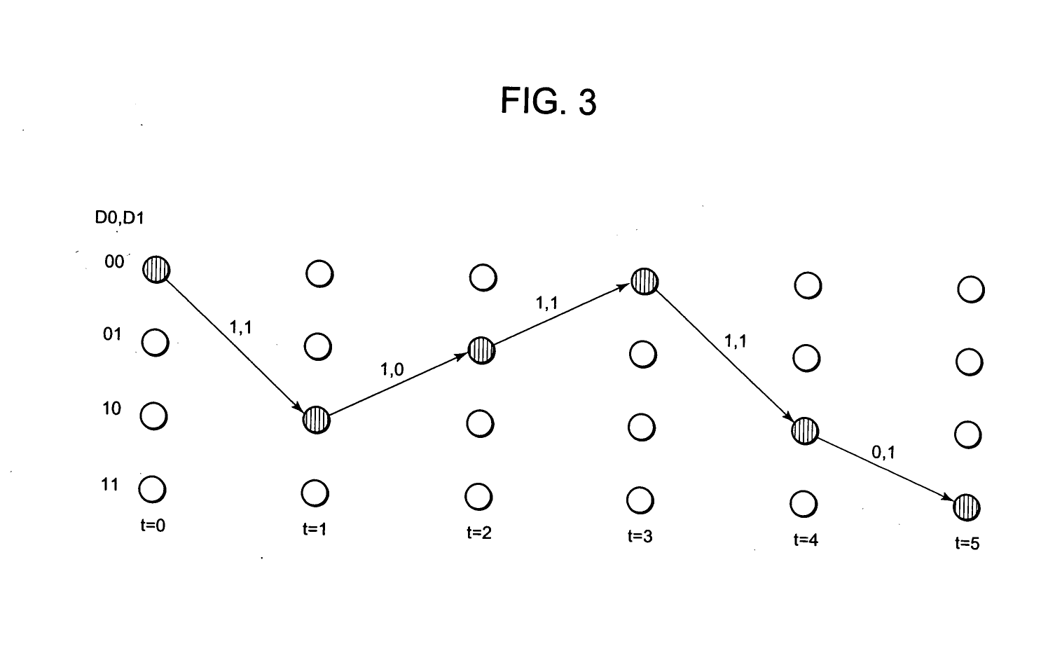

First, a description will be given in brief of a Viterbi algorithm in order to facilitate the understanding of the present invention. The convolutional decoding will be first described. Since the Viterbi algorithm is a decoding algorithm, it is necessary that the input data is coded. As the coding method, the conventional coding is used. FIG. 1 shows the convolutional coder.

The convolutional coder 20 shown in FIG. 1 includes two registers 21 and 22, and three logic circuits 23 to 25 that obtain exclusive OR. The constraint length of the coder 20 is 3(the number of registers+1). Since the coder 20 obtains 2-bit outputs (output 0, output 1) with respect to 1-bit input, the coding rate is 1/2.

The constraint length is directed to the number of past input bits required to obtain the output. When the constraint length is longer, the error correction performance is increased, but the configuration of the Viterbi decoding device becomes complicated. The coding rate is directed to the ratio of the input bits to the output bits with respect to the coder. In the case where the coding rate is smaller, that is, the number of bits of the output with respect to the input is large, the transmission rate becomes low, but the error correction performance is increased.

Now, a description will be given of a case in which data indicated in the following Table 1 is inputted. The input data to the convolutional coder 20 shown in FIG. 1 and the output data from the convolutional coder 20 are indicated in Table 1, and the state transition of the convolutional coder is indicated in Table 2.

TABLE 1

| | Input | | | | |
|---|---|---|---|---|---|
| | 1 | 0 | 0 | 1 | 1 |
| Output0, Output1 | 11 | 10 | 11 | 11 | 01 |

In this example, the initial values of the registers 21 and 22 at the time of starting the registers 21 and 22 are set to “0”, and therefore the initial states are (D0, D1)=(0, 0). In this state, when, for example, “1” is inputted from the input terminal in this state, the outputs become “output0, output1”=“1,1”, and at the next time, the states of, the registers 21 and 22 become (D0, D1)=(1, 0). On the other hand, when “0” is inputted from the input terminal, the outputs become “output 0, output 1”=“0, 0”, and at the next time, the states of the registers 21 and 22 become (D0, D1)=(0,0). In FIG. 2, numeric values indicated above arrows are “output0, output1”. Since the input is “0” or “1”, one state changes to only two kinds of states. Hence, two arrows are outputted from one state. When the value (input) indicated in Table 1 is inputted to the convolutional coder 20, the state (D0, D1) changes to (0,0), (1, 0), (0, 1), (0, 0), (1, 0), and (1,1) in the stated order, and the obtained results “output 0, output 1” become “1110111101”.

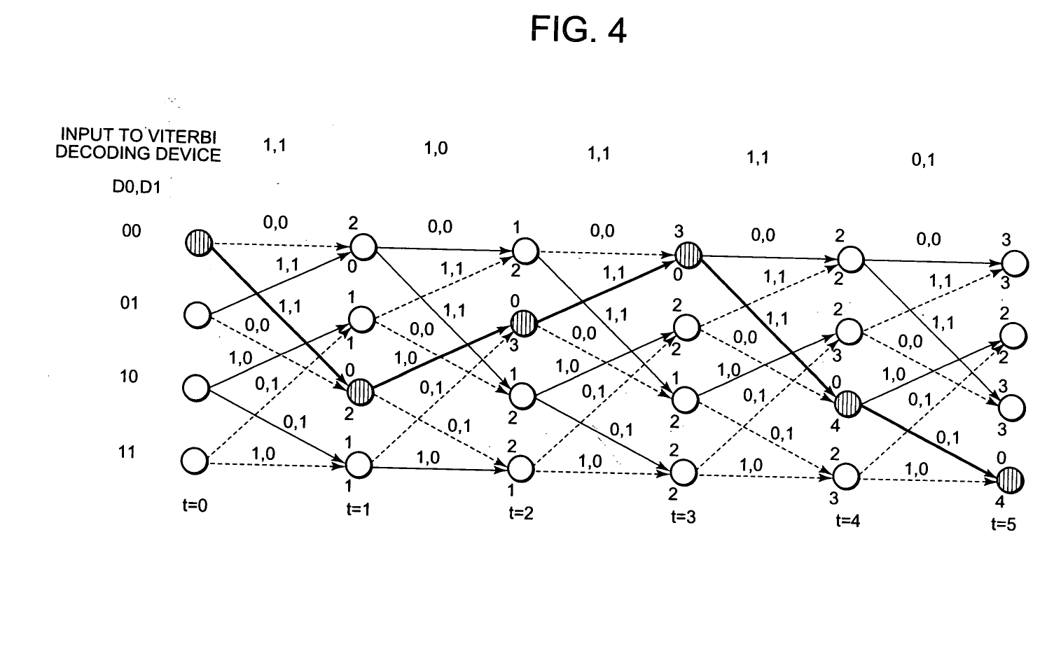

FIG. 4 shows a trellis diagram in the case where the convolutional coder 20 shown in FIG. 1 outputs the output data indicated in Table 1, and the output data is inputted to the Viterbi decoding device. The respective states at the respective time points of the trellis diagram correspond to the respective states (D0, D1) of the registers 21 and 22 of the convolutional coder shown in FIG. 1 at the respective time points. Two arrows that are directed toward directions of the subsequent time points from the respective states at the respective time points in the trellis diagram are called “branches”, which are indicative of “two state transitions” at the subsequent time points which can be taken by a certain state at a certain time point. Since the input to the convolutional coder 20 shown in FIG. 1 is “1” or “0”, there are two ways of transitions from one state at one time point to any states at the subsequent time point in the trellis diagram shown in FIG. 4.

For example, in the case where “0” of one bit is inputted to the convolutional coder 20 shown in FIG. 1 at a time point t=0, a state (D0, D1)=(0, 0) at the time point t=0 in the trellis diagram of FIG. 4 transits to a state (D0, D1)=(0,0) at the time point t=1. On the other hand, in the case where “1” of one bit is inputted to the convolutional coder 20 shown in FIG. 1 at the time point t=0, a state (D0, D1)=(0, 0) at the time point t=0 in the trellis diagram of FIG. 4 transits to a state (D0, D1)=(1,0) at the time point t=1. The numeric values described at the respective branches on the trellis diagram represent data that is outputted by the convolutional coder 20 shown in FIG. 1 when the respective states transit from one time point to the subsequent time point. The above numeric values are called “code words”. In the above-described example, when the state transits from the state (D0, D1)=(0,0) at the time point t=0 to the state (D0, D1)=(1,0), (output 0, output 1) is outputted from the convolutional coder 20. Also, an input to the Viterbi decoding device in FIG. 4 is directed to input data to the Viterbi decoding device when the state transits from one time point to the subsequent time point. The input is called “receive word”.

A course of the state transition which extends from a certain state at the initial time point on the trellis diagram to a certain state at a time point after the initial time point is called “path”. One decoding result is obtained by determining one path extending from the initial time point to a final time point on the trellis diagram. This is because when the path that extends from the initial time point to the final time point on the trellis diagram is determined, the branches at the respective time points which constitute the path are determined, and the code words at the respective time points including the initial time point to the final time point can be determined by the respective branches that constitute the path. When the code words at the respective time points including the initial time point to the final time point can be determined, the input data at the respective time points to the coder can be determined from the state transition of the coder, thereby obtaining the decoding result. When the determined path is correct with respect to the receive word, the decoding result is also correct whereas when the determined path is incorrect with respect to the receive word, the decoding result is also incorrect. Accordingly, it is necessary to determine a correct path with respect to the receive word in the Viterbi decoding. In order to determine the correct path with respect to the receive word in the Viterbi decoding, the likelihoods of the respective paths that extend from the state at the initial time point to the states at the time points after the initial time point on the trellis diagram are evaluated. In order to evaluate the likelihoods of the paths, the likelihoods of the respective state transitions with respect to the receive words at the respective time points are first required. This is because the path is the connection of the branches.

The likelihood of the transition from one state at one time point to another state at a subsequent time point of the one time point is called “branch metric”. The branch metric is calculated on the basis of the code words at the respective branches on the trellis diagram and the receive words corresponding to the respective branches. How to obtain the branch metric is different between hard decision and soft decision. For example, in the hard decision, hamming distances between the code words corresponding to the respective branches on the trellis diagram and the receive words corresponding to the respective branches are used. The hamming distance is directed to the different bit counts of two bit strings. Accordingly, in the case where the hamming distance is used in the branch metric, the likelihood of the transition becomes higher as the value of the branch metric is smaller.

As an example, let us consider the branch metric with respect to the state transition of from the state (D0, D1)=(0,0) at the time t=0 to the state (D0, D1)=(0,0) at the time t=0 in FIG. 4. The hamming distance between the value attached to the branch with respect to the state transition, that is, the code word (0,0) and the input to the Viterbi decoding device when the state transition occurs, that is, the receive word (1,1) is 2. Therefore, the branch metric is 2.

On the other hand, the branch metric with respect to the state transition of from the state (D0, D1)=(0,0) at t=0 to the state (D0, D1)=(0,0) at t=1 is calculated in the same manner, and becomes 0. The branch metric represents the likelihood of the state transition, and the hamming distance is used for the branch metric in FIG. 4. Therefore, it is possible to evaluate the state transition that is small in the value of the branch metric is more probable. Accordingly, it is possible to evaluate that the path from the state (D0, D1)=(0,1) at t=0 among the states that transits to the state (D0, D1)=(0,0) at t=1 is likelihood.

As described above, in order to determine the correct path with respect to the receive word in the Viterbi decoding, the likelihoods of the respective paths, which extend from the state at the initial time point to the states at the time points after the initial time point on the trellis diagram are evaluated to determine the maximum likelihood path that is the highest in the likelihood. In the Viterbi decoding, the likelihood of the path that comes to the respective states at the respective time points on the trellis diagram is evaluated by a value called “path metric”. The path metric is calculated by the sum of the branch metrics of the branches that constitute the respective paths that come to one state on the trellis diagram. However, when the math metrics of all the paths that come to the respective states at the respective time points are going to be obtained, the calculation amount becomes enormous. Under the circumstances, the following method is used in the Viterbi decoding. That is, only the paths that are determined to be highest in the likelihood among the paths that come to the respective states at the respective time points on the basis of the path metric are adopted as the survivor paths, and other paths are discarded to reduce the calculation amount.

As shown in FIG. 4, there are two branches that come to the respective states at the respective time points on the trellis diagram, and only the survivor paths are adopted at the respective states at the respective time points, and other paths are discarded. As a result, the number of paths that come to a certain state is always two. For that reason, the path metrics of the two paths that come to the certain state are compared with each other, and only one path that is higher in the likelihood is set as the survivor path on the basis of the comparison result. In FIG. 4, numeric values are indicated above and below the respective states, and a value of the path metric of the path from the upper side is indicated above the state whereas a value of the path metric of the path from the lower side is indicated below the state with respect to the respective states. In this example, since the hamming distance between the code word and the receive word is used for the branch metric, it is possible to determine that the likelihood is higher as the path metric is smaller. Hence, in FIG. 4, a path that is smaller in the path metric is selected from the two paths that come to the certain state as the survivor path.

For example, attention is paid to the time t=2 and the state (D0, D1)=(0,1) on the trellis diagram shown in FIG. 4. The path metric of the path that extends from the time t=0 and the state=(D0, D1)=(1,0) is 0, and the path metric of the path that extends from the time t=1 and the state=(D0, D1)=(1,1) is 3. Accordingly, the path that extends from the time t=1 and the state (D0, D1)=(1, 0), which is small in the path metric is set as the survivor path. This path is indicated by a solid line. The other path is discarded and indicated by a broken line. In this example, in the case where the path metrics of those paths are equal to each other, the paths that come to the respective states from the upper branches are set as the survivor paths in the respective states. Alternatively, the paths that come to the respective states from the lower branches can be set as the survivor paths.

Through the above-mentioned method, the maximum likelihood path from the initial time point to the final time point on the trellis diagram with respect to the receive words at the respective time points is determined on the basis of the path metrics in the respective states at the respective time points, thereby obtaining the decoding results on the basis of the path. In obtaining the decoding results in the Viterbi decoding, there is used a manner that is called “trace back”. The trace back is directed to a method in which information on whether a path that comes to the respective states from any one of two branches that come to the respective states at the respective time points on the trellis is set as the survivor path during a process of determining the maximum likelihood path on the basis of the path metric, or not, is stored in advance, and the path is traced back toward the initial time point from a sate that is highest in the likelihood at the final time point on the trellis diagram according to the information. In FIG. 4, the path indicated by the solid line with the state (D0, D1) which is smallest in the path metric as an origin is traced back from the time point t=5 to t=4, . . . t=0. In the example shown in FIG. 4, the decoding result is “0” when the present state is even ((D0, D1)=(0,0), (0,1)), and“1” when the present state is odd ((D0, D1)=(1,0), (1,1)). Hence, in the example shown in FIG. 4, the results are obtained in the order of “11001”. The result is not obtained in the initial state. The order is reversed into an original order, and the decoding sequence in Table 1 is obtained so that decoding can be conducted.

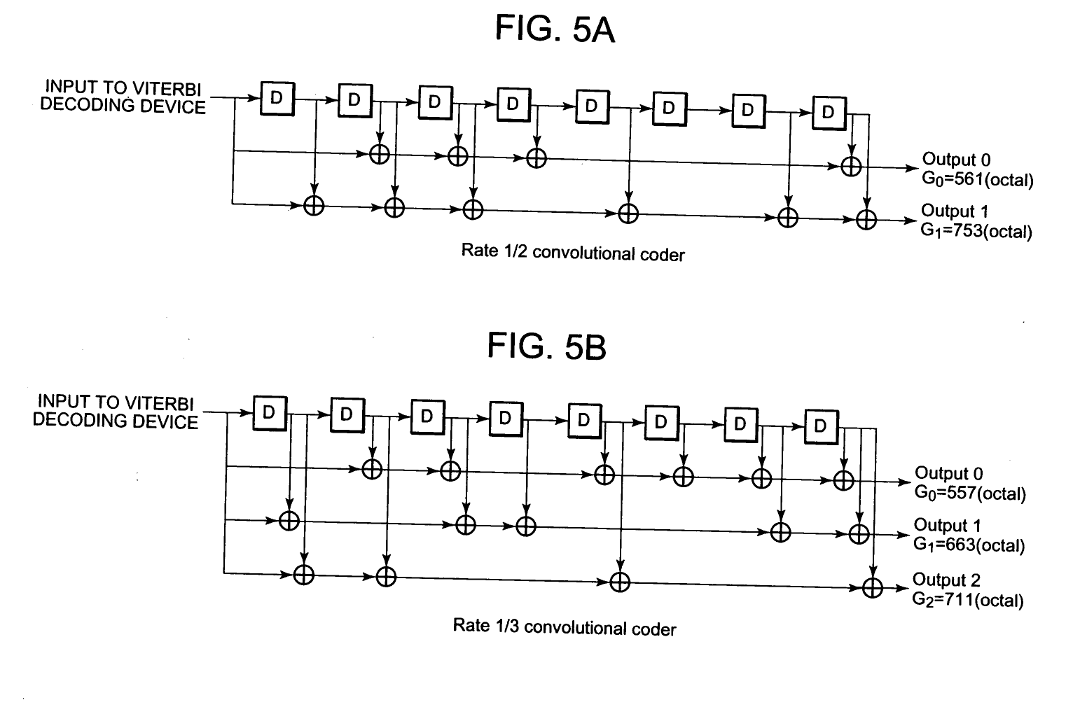

The convolutional coder used in the actual W-CDMA communication is formed of a convolutional coder (refer to FIGS. 5A and 5B) with eight registers, which inputs one bit and outputs two or three bits, and has the constraint length of 9, and the coding rate of 1/2 or 1/3.

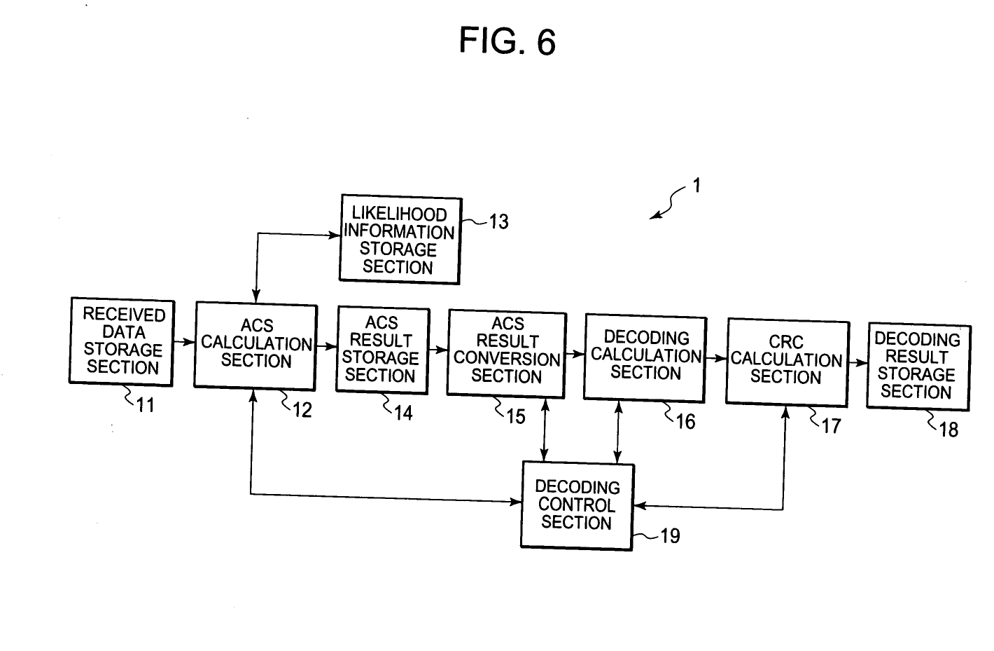

Subsequently, a description will be given of the Viterbi decoding device according to this embodiment. FIG. 6 is a block diagram showing a Viterbi decoding device according to this embodiment. The Viterbi decoding device 1 includes a received data storage section 11, an ACS calculation section 12, a likelihood information storage section 13, an ACS result storage section 14, an ACS result conversion section 15, a decoding calculation section 16, a CRC calculation section 17, a decoding result storage section 18, and a decoding control section 19.

The received data storage section 11 receives and stores the received data as data used for receive decoding. The ACS calculation section 12 is a portion that is a core of the Viterbi decoding calculation. A state A and a state B exist at one time point on the trellis diagram, and each of the states A and B includes a branch that extends from the one time point to a state C at a time point after the one time point. In this situation, the ACS calculation section 12 compares the result of adding the branch metric of a branch that extends from the state A to the state C to the path metric of the survivor path that reaches the state A with the result of adding the branch metric of a branch that extends from the state B to the state C to the path metric of the survivor path that reaches the state B. Then, the path that is higher in the likelihood which reaches the state C is adopted as the survivor path on the basis of the comparison result. Then, a process of selecting one branch that constitutes the survivor path from the branches that extend from the states A and B to the state C is conducted.

The likelihood information storage section 13 is a portion that stores the likelihood information that has been added in the ACS calculation, and reuses the stored likelihood information at the time of the subsequent likelihood calculation. The likelihood information is repetitively used, thereby making it possible to enhance the error correction performance.

The ACS result storage section 14 is a portion that stores the selection results of the ACS calculation, and obtains the final decoding results from that information.

The ACS result conversion section 15 is a portion that forcedly converts the results of the ACS, and changes the transition due to the converting operation to enable the trace back. More specifically, this is a process of inverting the select of the read ACS calculation by bits. The details of this operation will be described later.

The decoding calculation section 16 conducts trace back to obtain the decoding result related to the decoding path of a first candidate (first decoding path) that is highest in the likelihood. The CRC calculation section 17 conducts the CRC calculation to conduct the error determination of the decoding result in the case where the CRC is included in the obtained data. In this situation, in the case where an error is found in the decoding result due to the CRC, in this embodiment, the decoding path that is a second candidate is traced back by using the results of the ACS result conversion section 15 without conducting the retransmission of the data to again conduct the decoding. The decoding result storage section 18 stores the decoded data. The decoding control section 19 controls the Viterbi decoding device. That is, the decoding control section 19 controls the operation of the respective blocks.

In the Viterbi decoding device, upon receiving the received data, the decoding calculation section 16 obtains the first decoding path on the basis of the results of the ACS result storage section 14. Then, the decoding calculation section 16 obtains the decoded data with the use of the first decoding path. The CRC calculation section 17 detects an error in the decoded data. In the case where an error is in the first decoded data as a result of the error detection, the ACS result conversion section 15 converts the results of the ACS.

With the above operation, the decoding calculation section 16 changes the branch that has been selected as a branch which comes to the first state to another branch in the first decoding path on the trellis diagram, conducts trace back, and obtains the second decoding path. Then, the decoding calculation section 16 again obtains the decoded data with the use of the second decoding path. The CRC calculation section 17 again conducts the CRC determination to obtain the decoding results with the use of the second decoding path that is the second candidate without conducting the retransmission of the data even if an error is detected in the first decoding path that is the first candidate. As a result, the decoding calculation section 16 improves the probability that the error is corrected. In this example, in the case where an error is detected in the decoded data of the second decoding path, the ACS result conversion section 15 again converts the results of the ACS, likewise. With the above conversion, the decoding calculation section 16 changes the branch that has been selected as a branch that comes to the second state which has been traced back from the first state in the first decoding path to another branch in the first decoding path, conducts trace back, and obtains the third decoding path. Then, the decoding calculation section 16 again obtains the decoded data with the use of the third decoding path. In this way, for example, the decoding calculation section 16 changes the decoding path until the CRC determination result is acceptable or by a given number to obtain the decoding results. As a result, it is possible to improve the error correction performance.

Also, as will be described later, the decoding path that is selected as the second candidate is not limited to the decoding path that traces back the branch which is different from that branch that reaches the final state of the first decoding path. Alternatively, in the final state on the trellis diagram, in the case where the branch is traced back from a state in which the path metric is smallest to select the first decoding path, the decoding path that is traced back from a state in which the path metric is second smallest in the final state can be set as the second candidate.

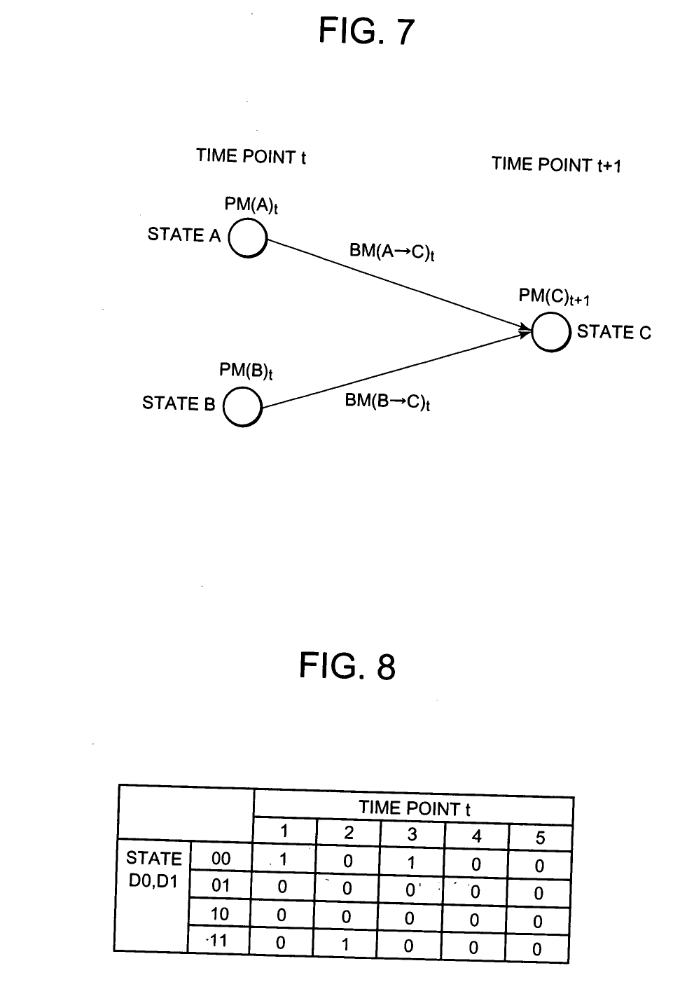

Subsequently, a description will be given in more detail of the Viterbi decoding device according to this embodiment. First, the ACS calculation section 12 will be described. FIG. 7 shows the ACS at the time of transiting from a certain time point t to t+1. As described above, there exist two paths that reach the state C at the time point t+1. It is assumed that the original states of those paths are the states A and B. When it is assumed that the path metric from the time point 0 to t is PMt, PM of the respective states is represented as PM (A) and PM (B) t. The ACS calculation section 12 compares the results of adding the branch metric BM (hamming distance/Euclidean distance) BM (BM(A→C)t, BM(B→C)t) which is obtained from the input data at the time point t to the PM (PM(A)t, PM(B)t) of the respective states with each other, and selects the smaller value, that is, the path whose likelihood is larger. The following expression is a selection expression:

```
if(PM(A)t + BM(A→C)t < = PM(B)t + BM(B→C)t) {
  PM(C)t+1 = PM(A)t + BM(A→C)t
  SEL = 0 (State A)
}else{
  PM(C)t+1 = PM(B)t + BM(B→C)t
  SEL = 1 (State B)
}
```

In the above expression, the likelihood is larger as PM and BM are smaller, which is attributable to the fact that this embodiment uses the hamming distance of the receive word and the code word for the branch metric. Accordingly, it is possible that the different branch metrics are defined, and the likelihood is larger as the branch metric and the path metric are larger. In the case where the likelihood is larger as the branch metric and the path metric are smaller, the initial value can be set so that the PM in the initial state is 0 and the PM in other states is sufficiently large. For example, when the initial state is 0, PM (0)0 is 0, and PM (X) (X≠0) is a sufficient large value. In the case where the likelihood is larger as PM and BM are larger, the reverse initial setting is conducted.

SEL is information on the selected path (survivor path) Since there exist only two paths that reach the state C, it is found which path is selected by the information (0,1) of 1 bit. This example shows a case in which “0” is stored in the memory when the state A is selected (for example, a state in which the branch passes through the upper arrow in FIG. 4), and “1” is stored in the memory when the state B is selected (for example, a state in which the branch passes through the lower arrow in FIG. 4). The obtained PM (C) t+1 is stored in the likelihood information storage section 13, and the SEL is stored in the ACS result storage section 14. FIG. 8 is a diagram showing the results that are stored in the ACS result storage section 14. In this way, the information SEL (ACS results) on the survivor paths are stored in association with the time point t and the state. In this example, PM (C) t+1 is used in the ACS calculation at the subsequent time point, and sequentially overwritten. The ACS result is used in obtaining the decoding result. Also, in this embodiment, the ACS result is also used in changing over, the decoding path as will be described later.

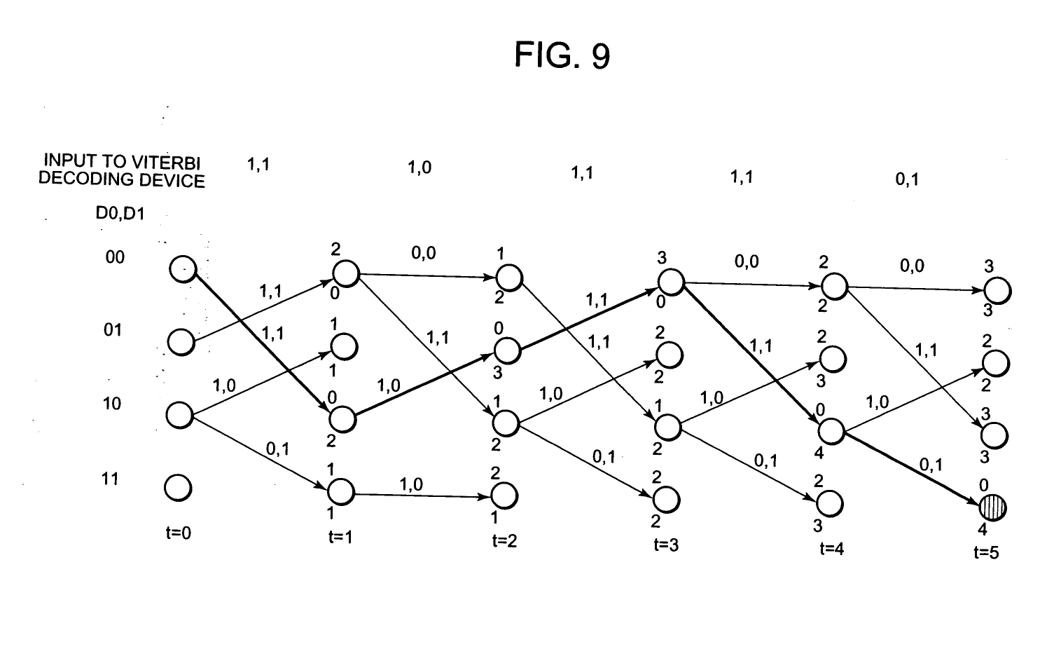

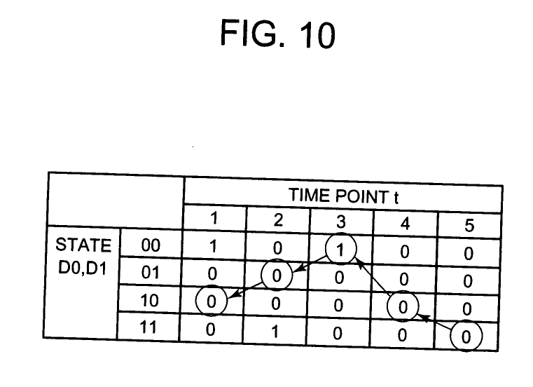

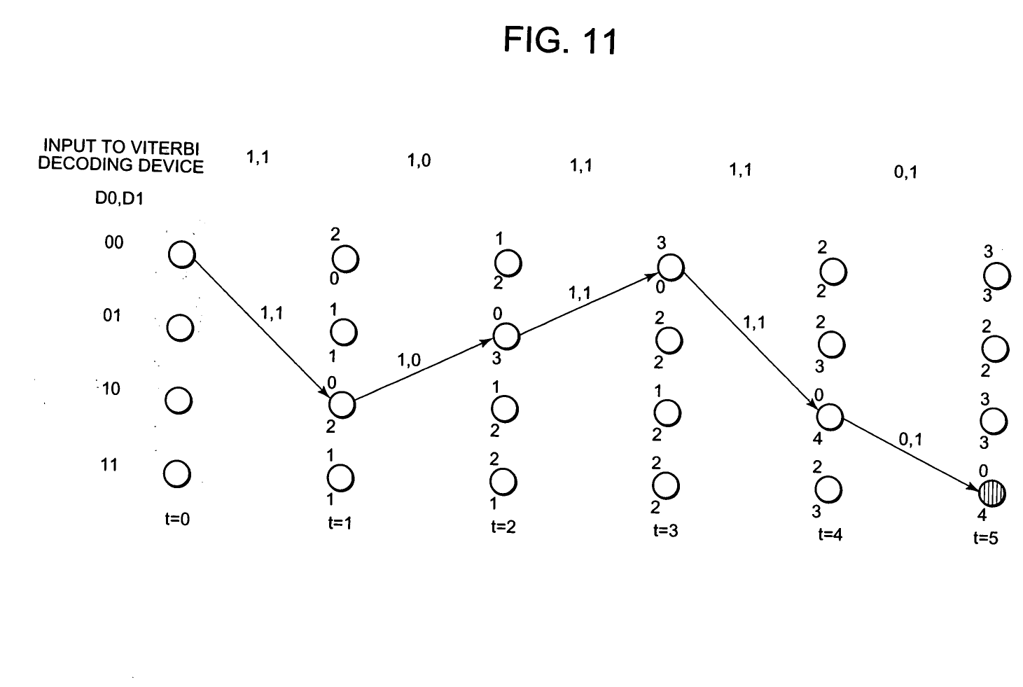

Subsequently, the decoding process of the decoding calculation section 16 will be described. FIG. 9 shows the survivor path (ACS result) of FIG. 4. A state in which the path metric is smallest in the final ACS calculation is a state (11) indicated by shading. That is, in this case, the path that finally reaches the state (11) from the input data is likelihood. It is found that there exists only one survivor path (ACS results) that reaches this state. The decoding results are obtained by tracing back the path. As described above, the information on the survivor path is stored in the ACS result storage section 14. That is, as shown in FIG. 7, the state A (for example, the upper path) can be traced back when the storage result SEL in the ACS result storage section 14 is “0”, and the state B (for example, the lower path) can be traced back when the storage result SEL is “1”. In this way, as shown in FIGS. 10 and 11, the ACS results are traced back, thereby making it possible to obtain the decoding results.

The 8-bit data of normally “0” which is called “tail bit” is inserted at the end of the convolutional coding in the W-CDMA communication, to thereby set the state in which the likelihood is highest at the final time point of the ACS calculation to 0. That is, in this example, “0” of two bits is inputted as the tail bit, to thereby set the final state to (00). In the present specification, this state is called “state zero”.

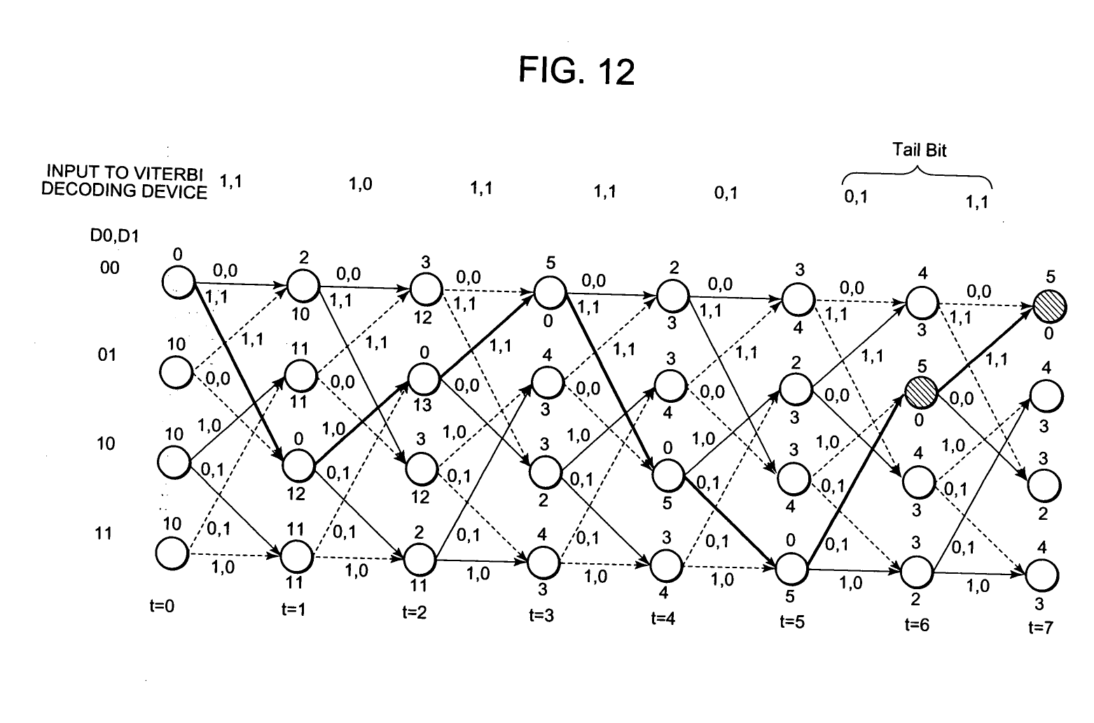

FIG. 12 is a trellis diagram showing a case in which “0” of two bits is inserted at the end of the input data that is inputted to the coder 20 as the tail bit. Table 2 represents the input/output data in the coder 20 in which the tail bit is added to the data shown in Table 1.

TABLE 2

| | Input | | | | | | |
|---|---|---|---|---|---|---|---|
| | 1 | 0 | 0 | 1 | 1 | 0 | 0 |
| Output0, Output1 | 11 | 10 | 11 | 11 | 01 | 01 | 01 |

When “0” is inputted twice after all of data has been input to the coder 20, (D0, D1)=(0,0) is always satisfied. That is, the trellis is terminated with the state of zero, and the input/output data is represented by the above Table 2. As shown in FIG. 12, when the tail bit is inserted, the final state is guided to a state (0,0) at the time point t=6 and t=7, and the state is zero at the time of terminating the trellis.

FIG. 12 shows a case in which the initial value of the register of the convolutional coder is 0. The tail bit is inserted with the result that the trellis is terminated so that the final state is state zero. Also, in FIG. 12, the initial state of (D0, D1) is defined as (0,0). That is, where to be traced back should be the state (0,0), and in order to satisfy this condition, PM is weighted in advance. As a result, the state reaches the state zero when the state is finally traced back. A method of inserting the tail bit to terminate the trellis is general. However, in the following description, for simplification of the description and drawings, a description will be made assuming that the tail bit is not inserted. Also, it is assumed that the initial state of (D0, D1) is not also defined (PM is not weighted).

The path that traces back the survivor path from the state in which the likelihood in the above manner is highest is the first decoding path. As described above, the state can be decoded to “0” or “1” according to the even or odd of the state. The decoding results are inputted to the CRC calculation section 17, and the decoding results are inspected by the CRC.

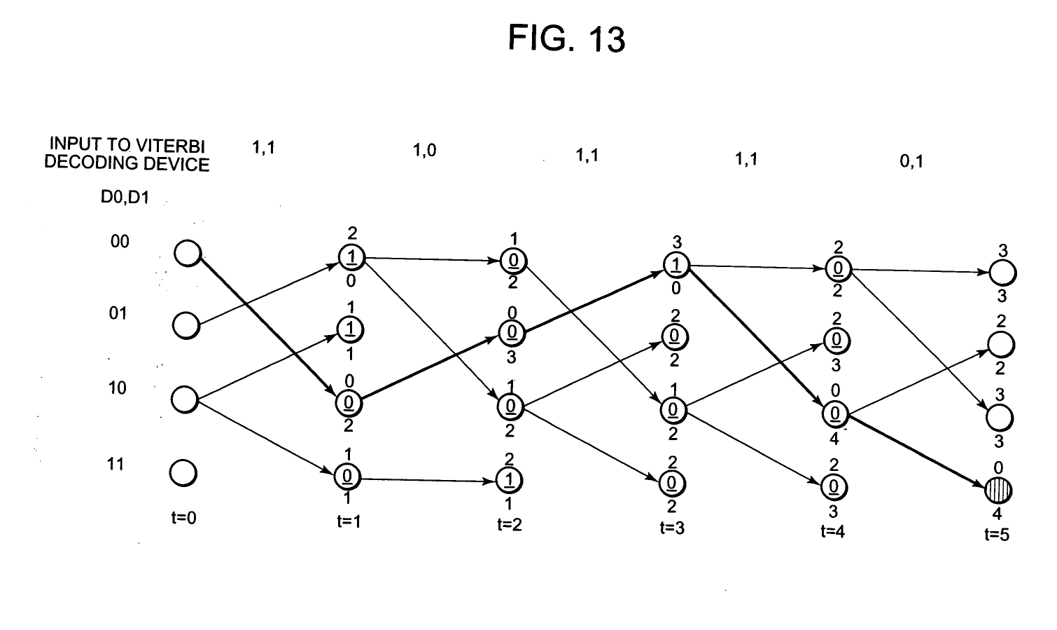

Subsequently, the details of the decoding calculation section 16 will be described. The ACS results are stored with binary (1 bit) information of 0 and 1 as shown in FIG. 10. In this embodiment, as described above, the path metrics of two paths that reach a certain state are compared with each other. In the case where the path having the smaller path metric is at the upper side, “0” is stored as the ACS result. On the other hand, in the case where the path is at the lower side, “1” is stored as the ACS result. FIG. 13 shows the survivor path. In this example, in the respective states, underlined numeric values represent the ACS results. In this example, in the case where the start time point is set to the time point 0(t=0), there exist six time points to a time point 5(t=5). There exist four states including (00) to (11). Hence, as shown in FIGS. 8 and 10, (the number of time points−1)×the number of states=20 bits exist as the ACS results. Because the initial state (t=0) has no ACS results, 1 is subtracted from the number of time points.

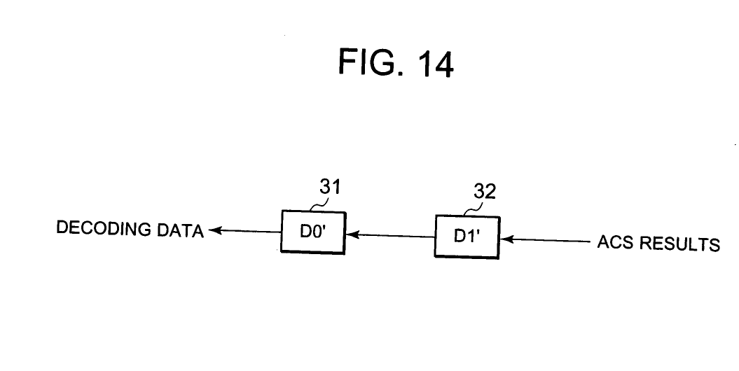

The decoding calculation section 16 reads data indicated by circles in FIG. 10 at the time of trace back. In this example, since the state of the final time point (t=5) is selected as “11”, data at fourth row and fifth column is read. It is found that the read data is “0”. The decoded data is obtained from those information items, and FIG. 14 is used in decoding.

D0′(31) and D1′(32) denote flip-flops. First, a state in which the trace back starts is set in the flip-flops 31 and 32 (D0′, D1′). In this example, since the state (11) is a state of the trace back start, D0′=1 and D1′=1 are set. Then, the value “0”(fifth row and fourth column) which is read from the ACS result storing RAM is inputted to the flip-flop 32 (D1′). As a result, the data of the flip-flop 32 (D1′) is outputted to the flip-flop 32 (D0′), and the data of the flip-flop 32 (D0′) is outputted as the decoding results (decoded data). Since the data that has been stored in the flip-flop 31 (D0′) is “1”, the first decoding results are “1”.

Subsequently, the ACS results of the flip-flops 31 and 32 (D0′, D1′) at the time point 4(t=4) are read. Since the ACS result “0” at t=5 is inputted to the flip-flop 32 (D1′), (D0′,D1′)=(1,0) is now satisfied. The ACS results of the state (1,0) at t=4 are read. In this example, “0” is obtained. When “0” is inputted to the flip-flop 32 (D1′), “1” is outputted as the decoding result. When the above process is executed until t=1, the decoding result of “11001” can be obtained. Since the results are obtained from behind, the order is reversed, and “10011” becomes the final decoding results.

Then, the decoding results are determined by CRC. In this situation, when an error exists in the decoding results, the ACS result conversion section 15 converts the ACS result, and conducts the following process for selecting the second decoding candidate.

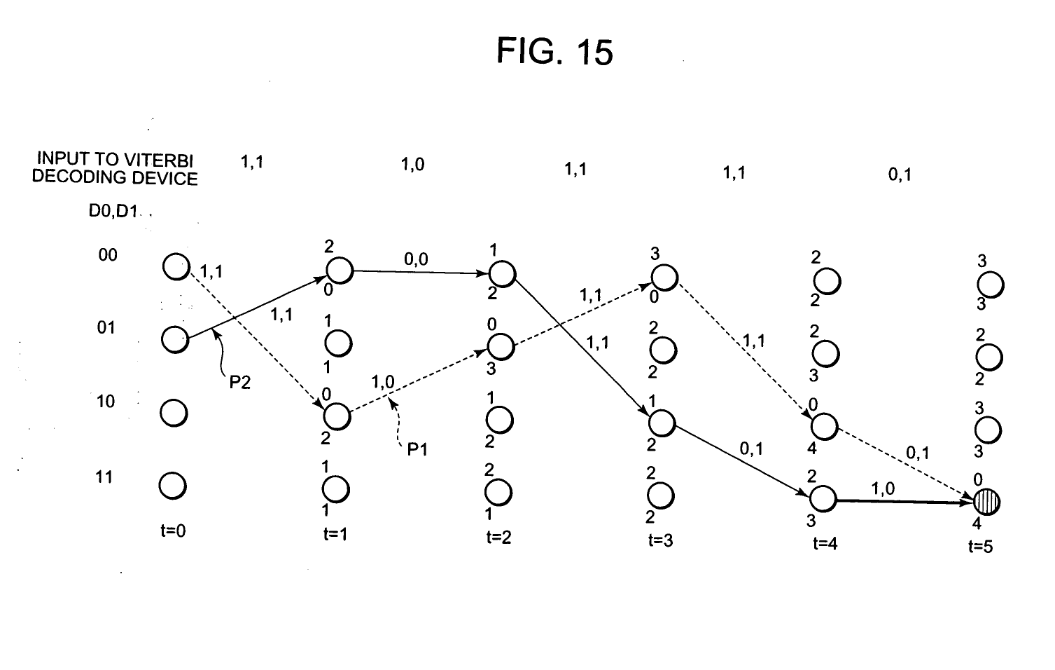

Subsequently, the processing of the ACS result conversion section 15 will be described. As shown in FIG. 11, the decoding result can be obtained by tracing back the survivor path of the ACS. In the case where the error determination result is indicative of an error, the decoding path of the second candidate is selected in this embodiment. That is, in the case where the maximum decoding results is an error NG determination, a part of the ACS results is converted to conduct the redecoding. In this case, as shown in FIG. 15, a path indicated by a solid line is restored as a branch different from the first decoding path P1 in the branches that reach the state (11) that is selected as the state at the final time point of t=5. As described above, because there are two paths that reach a certain state, and it is determined from which state the certain state is transited, the unselected path can be restored. Since the above ACS result storage section 14 has the information on the path with binary of “0” or, “1”, the restoration can be conducted by reversing the bit of the path to be restored. Because the information on the survivor path that reaches the restored path remains, the decoding result can be obtained by tracing back the survivor path. That is, in this embodiment, any specific memory is not required in selecting the decoding path of the second candidate.

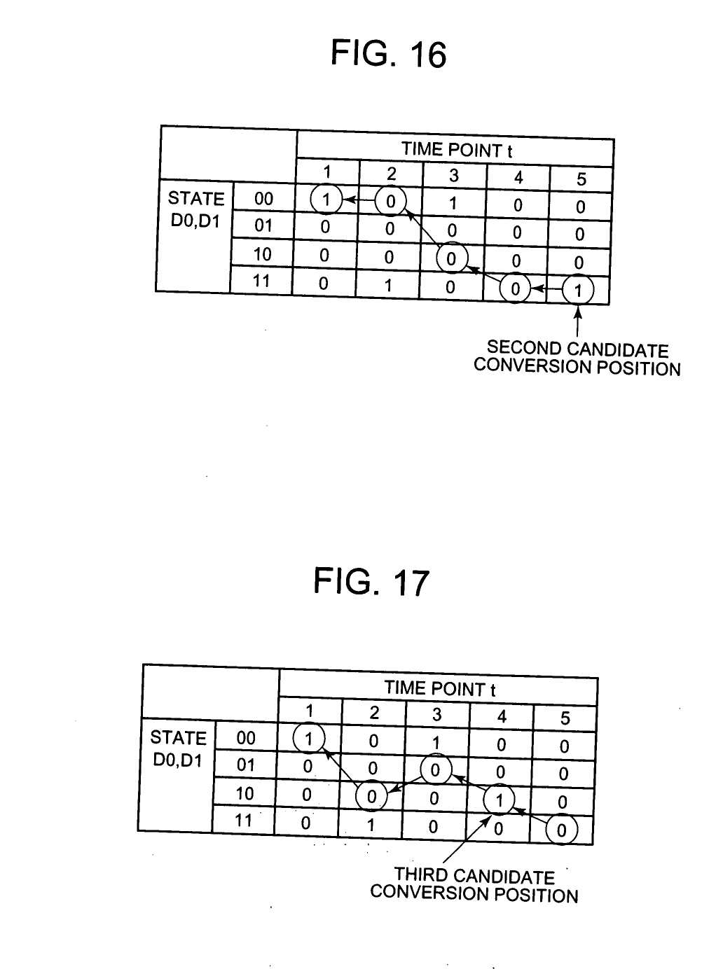

The processing of the ACS result conversion section 15 will be described in more detail. FIG. 16 shows the ACS result storage section 14 in the case of selecting the second decoding path of the second candidate. In the conversion bit, as shown in FIG. 16, the second candidate reverses the ACS result of the state (11) at the start point of the trace back (the final point of the ACS), that is, at t=5 to conduct trace back. The decoding result can be obtained in the same manner by inputting the reversed ACS result to the decoder shown in FIG. 14.

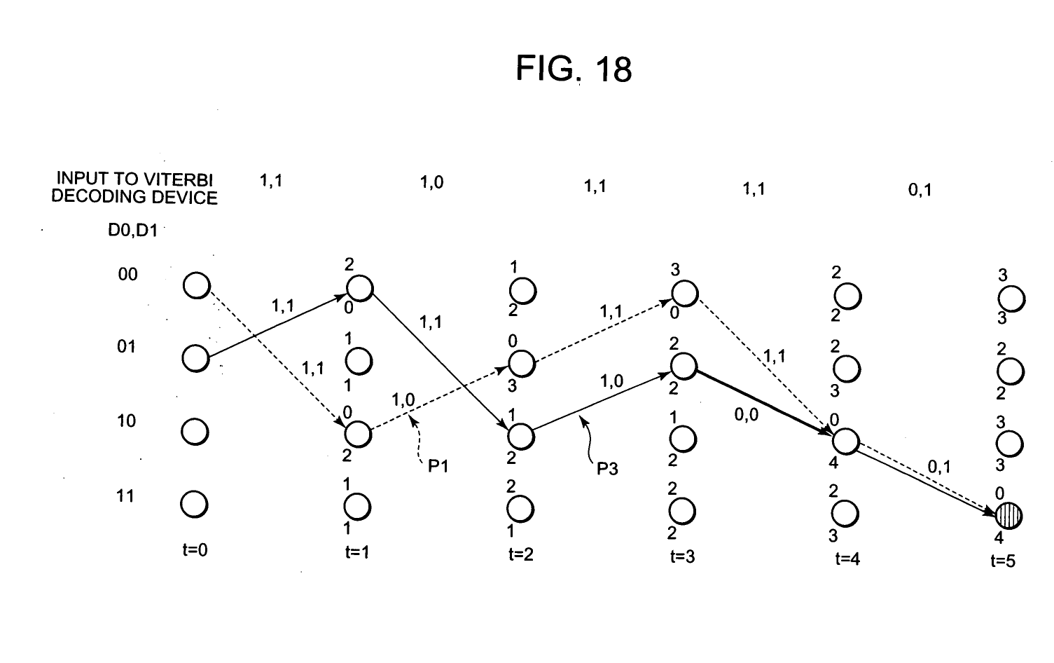

In the case where the decoding result of the second decoding path that is the second candidate is detected as the error, the ACS result conversion section 15 reverses the ACS result so as to select the third decoding path that is a third candidate. As shown in FIGS. 17 and 18, the third candidate reverses the ACS result at a point (next to the final point of the ACS) subsequent to the start point of the trace back, that is, the state (10) at t=4 to conduct the trace back. Similarly, as a fourth candidate and a fifth candidate, trace back is conducted while the positions of the inverted bits are shifted by one time point.

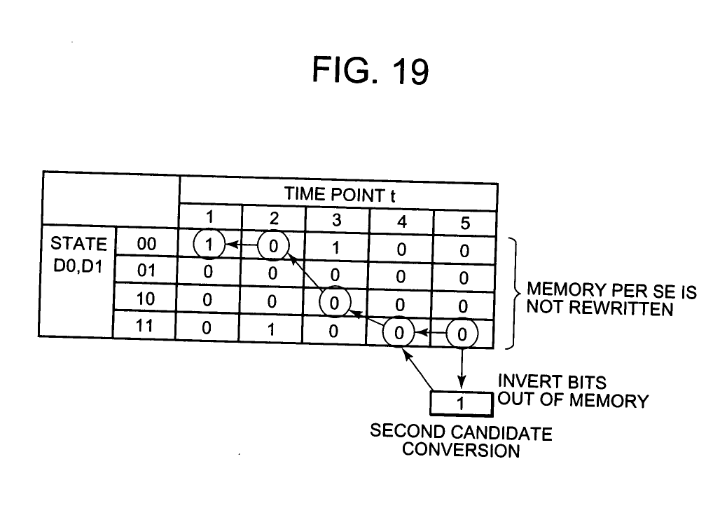

The contents in the ACS result memory are rewritten in FIGS. 16 and 17, but in the case where the result candidate is in error, the memory must be rewritten again. Therefore, in the real circuit, the bit is inverted after the ACS result is read from the ACS result storage section as shown in FIG. 19.

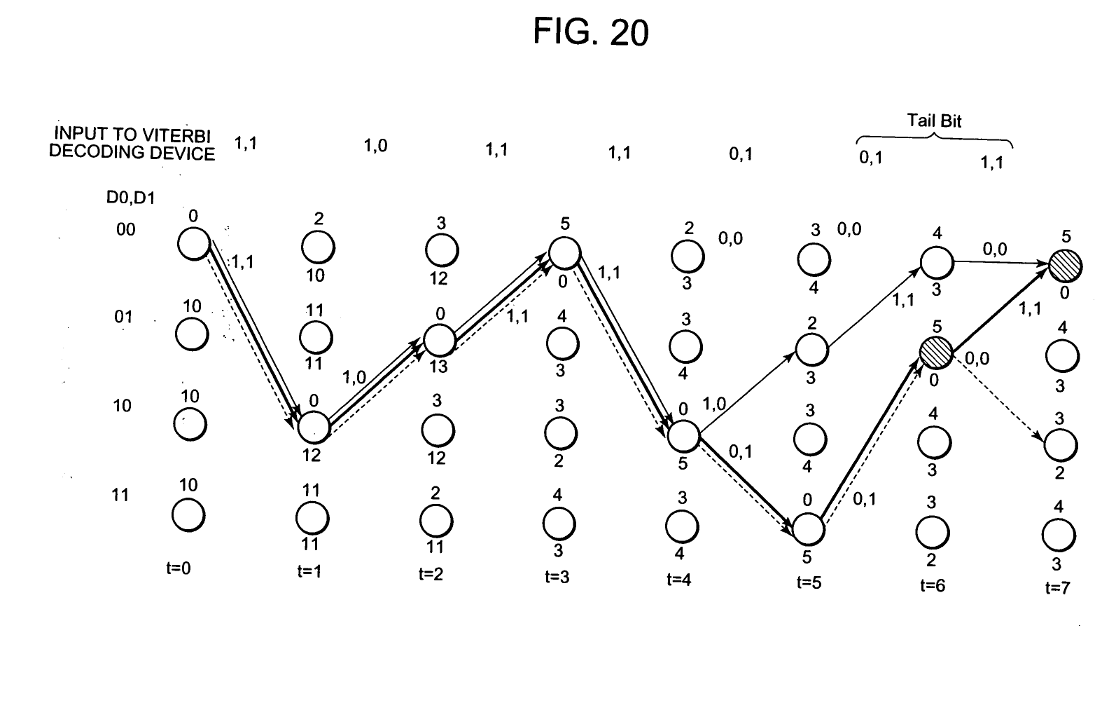

Now, a description will be given of a case in which the trellis is terminated as shown in FIG. 12. FIG. 20 is a diagram showing only the survivor path extracted from the trellis diagram shown in FIG. 12. Similarly to FIG. 12, FIG. 20 shows a case in which the initial value of the register of the convolutional coder is 0. Referring to FIG. 20, a bold solid line indicates the first candidate, and a thin solid line indicates the second candidate. The output result of the first candidate is “0011001”. The lead two bits are removed because of tail bits, and the order of the result is reversed to obtain the final result of “10011”. In this example, the state in which the PM is smallest in the final state is the state (0,0), and hence the path in which the likelihood is highest is the path indicated by the bold solid line. The state in which the PM is second smallest in the final state is the state (1,0), and hence the path in which the likelihood is second highest is the path indicated by a broken line. When the paths are viewed in the higher order of the likelihood, the path of the second candidate should be the path indicated by the broken line, but is not dealt with as the second candidate in this example.

That is, as described above, in this embodiment, it is possible that the decoding path of the first candidate is set as the decoding path that is traced back from the state in which the likelihood is highest in the final state. Also, it is possible that the decoding path of the second candidate is set as the decoding path that is traced back from the state in which the likelihood is second highest in the final state. The details will be described later. However, in this example, there is a rule that the final state becomes 0 in the case where the tail bit is inserted, that is, since states other than the state (0,0) cannot be taken, a manner in which trace back is conducted in the likelihood order of the final state cannot be taken. Hence, in this case, the second candidate becomes the decoding path that traces back the branch which reaches the final time point=state zero of the first decoding path which is the first candidate as a branch different from the first decoding path. For that reason, the decoding path of the second candidate becomes the path of the thin solid line that starts from the state zero (state (0,0)). In this example, the PM of the final state (state (0,0)) of the decoding path of the second candidate is 5.

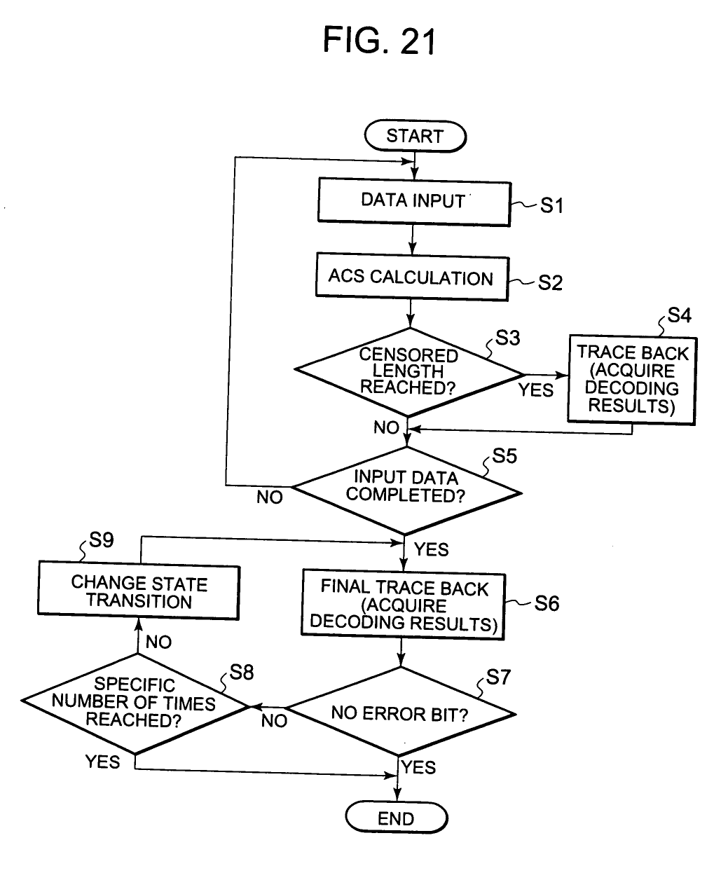

Subsequently, a description will be given of the Viterbi decoding method according to this embodiment. FIG. 21 is a flowchart showing the Viterbi decoding method according to this embodiment. First, data is inputted to the ACS calculation section 12 from the received data storage section 11 shown in FIG. 6 (Step S1). The ACS calculation section 12 executes the ACS calculation as described above (Step S2). Then, in the case where the ACS calculation reaches a given censored length (yes in Step S3), the decoding calculation section 16 refers to the ACS result that is stored in the ACS result storage section 14, and conducts the trace back to acquire the decoding result. Then, the decoding calculation section 16 stores the decoding result in the decoding result storage section 18 while conducting the CRC calculation. The decoding calculation section 16 continues the above operation until all of the input data is inputted (Step S5.)

Upon completion of inputting all of the data, the decoding calculation section 16.obtains the final decoding result due to the trace back (Step S6). For example, in the W-CDMA communication, because CRC is added to not each of the input data but the data block of a certain unit, the decoding calculation section 16 acquires the decoding result of the unit data block. Then, the decoding calculation section 16 detects the error bit due to the CRC (Step S7), and sequentially restores the second candidate and the third candidate if there is an error bit. First, it is determined whether the number of redecoding reaches a given number of times, or not (Step S8), and when the number of redecoding is equal to or lower than a given number of times, the ACS result conversion section 15 reads the ACS result that is stored in the ACS result storage section 14, and inverts the bits (Step S9). Then, the decoding calculation section 16 traces back the decoding path of the second candidate with reference to the inverted ACS result to acquire the decoding result (Step S6). In this way, the decoding is repeated until no error is detected, or by a given number of times. In this example, the decoding path of the subsequent candidate is selected until the number of decoding reaches the given number of times in Step S8 as described above.

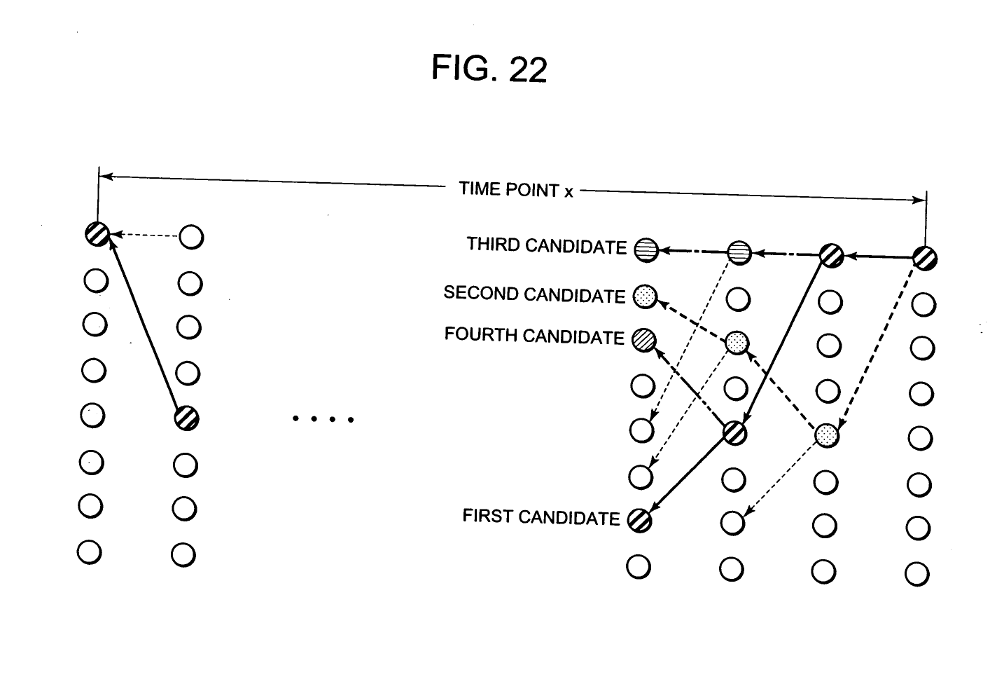

FIG. 22 shows a trellis diagram of the convolutional coder of a constraint length 4. As described above, it is normal that the convolution code is transited to the state zero at the time of terminating the trellis by inserting the tail bit of “0”. The path is traced back from the final state while the higher likelihood of the path that is transited to the final state is selected, to thereby obtain the decoding result of the first candidate.

It is determined whether the decoding result of the first candidate is correct, or not, and when the determination is affirmative, the decoding is terminated. On the other hand, when the determination is negative, the second candidate is decoded. The second candidate is one of the final paths which is not selected, and the path higher in the likelihood is traced back from the second candidate to obtain the decoding result. The decoding result of the second candidate is again subjected to the error determination, and when there is no error, the decoding is terminated. Also, when there is an error, the third candidate starts to be decoded. The third candidate selects a path which is in a state next to the final path and has not been selected, and traces back the path that is higher in the likelihood. The fourth candidate and the fifth candidate select paths that are second and third to the final path which have not been selected, and thereafter the path higher in the likelihood is traced back.

As described above, because the ACS result storage section 14 stores the information (ACS result) on the path of the maximum likelihood which reaches each of the states, even if the ACS result storage section 14 selects the path such as the second candidate or the third candidate, the ACS result storage section 14 is capable of tracing back the subsequent maximum likelihood path, and is capable of obtaining the decoding result.

This example can be applied to even a case in which the trellis is not terminated, and in this case, the first candidate traces back the maximum likelihood path from a state in which the likelihood is highest (at the present time point), and the second candidate traces back the maximum likelihood path from a path that reaches a'state that is highest in the likelihood at the present time point and is not maximum likelihood. Alternatively, the second candidate can trace back the maximum likelihood path from a state that is second highest in the likelihood at the present time point.

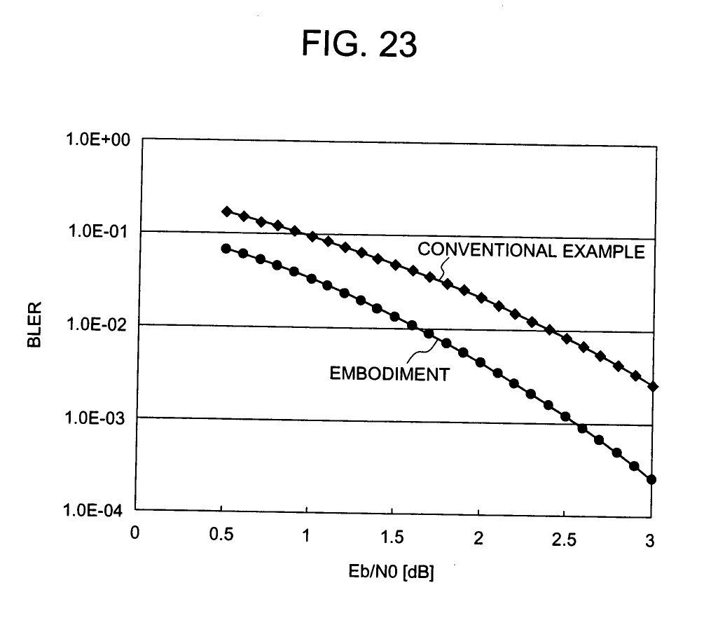

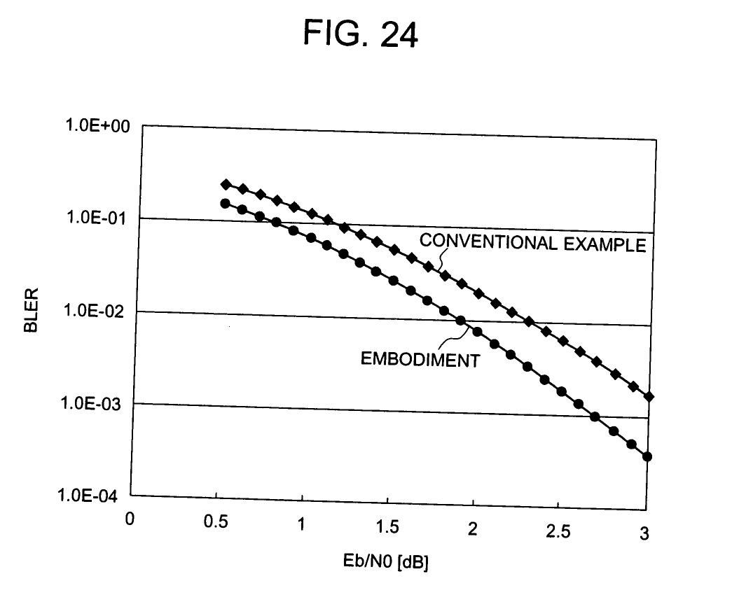

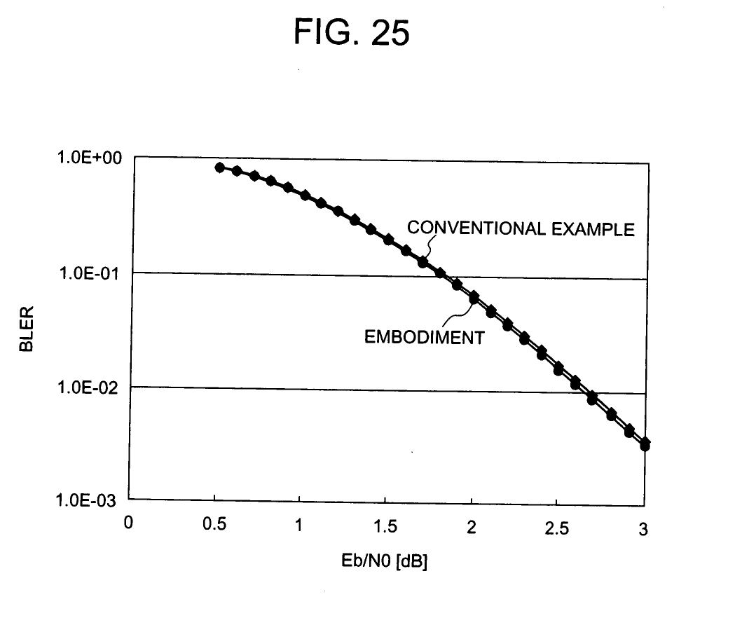

FIGS. 23 to 25 are graphs showing the results obtained by applying the Viterbi decoding method according to this embodiment as compared with the general Viterbi decoding device (conventional example) which terminates the decoding with the first candidate. FIG. 23 shows the decoding results under the conditions where the convolutional coding rate is 1/3, the TrBK (transport block) size is 10 bits, the CRC is 16 bits, and the CdBK (code block) size is 26 bits. FIG. 24 shows the decoding results under the conditions where the convolutional coding rate is 1/3, the TrBK size is 41 bits, the CRC is 16 bits, and the CdBK size is 57 bits. FIG. 25 shows the decoding results under the conditions where the convolutional coding rate is 1/3, the TrBK size is 488 bits, the CRC is 16 bits, and the CdBK size is 504 bits. The axis of abscissa represents a signal to noise ratio (Eb/N0, Eb is energy per 1 bit, NO is a noise power spectrum density), the axis of ordinate represents BLER (block error rate) As shown in FIGS. 23 to 25, the error correction performance is improved in any cases, and the error correction performance is larger as the data size is smaller.

In this embodiment, when the decoding result is the error in the first candidate, the candidate path that is the second candidate is selected to conduct the redecoding. When the decoding result of the second candidate is the error, the decoding path that is the third candidate is selected to conduct the redecoding. That is, in the case where an error is detected in the decoded data of an N-th (N≧2) decoding path, there is used the decoded data of an (N+1)-th decoding path that has been traced back at the time point t=(N−1) from the final state (state zero) in the first decoding path. As a result, it is possible to improve the error correction performance as compared with the conventional method that decodes nothing other than the first decoding path. Also, in this embodiment, there is always one kind of survivor path that is selected as the second and third candidates, and the redecoding can be conducted by using the ACS result which is normally held. For that reason, no newly added hardware is required, and the error correction performance can be improved in the extremely simple method.

Subsequently, the reason that the error correction performance is improved in this embodiment will be described. Because the data that has been transmitted from the transmitting side is added with noises on a transmission line, ideal data is not received at the receiving side. The Viterbi decoding estimates the original data on the basis of those data, and issues a reply.

The normal Viterbi decoder (decoding device) issues a reply having the maximum likelihood from the given conditions. Since it is not known whether the likelihood reply is correct, or not, at that time point, the error determination is conducted by using the error detection code such as the CRC. In this case, it is necessary to transmit the CRC together at the time of transmission. In the case where the determination is the error, the receiving side gives the transmitting side a retransmission request.

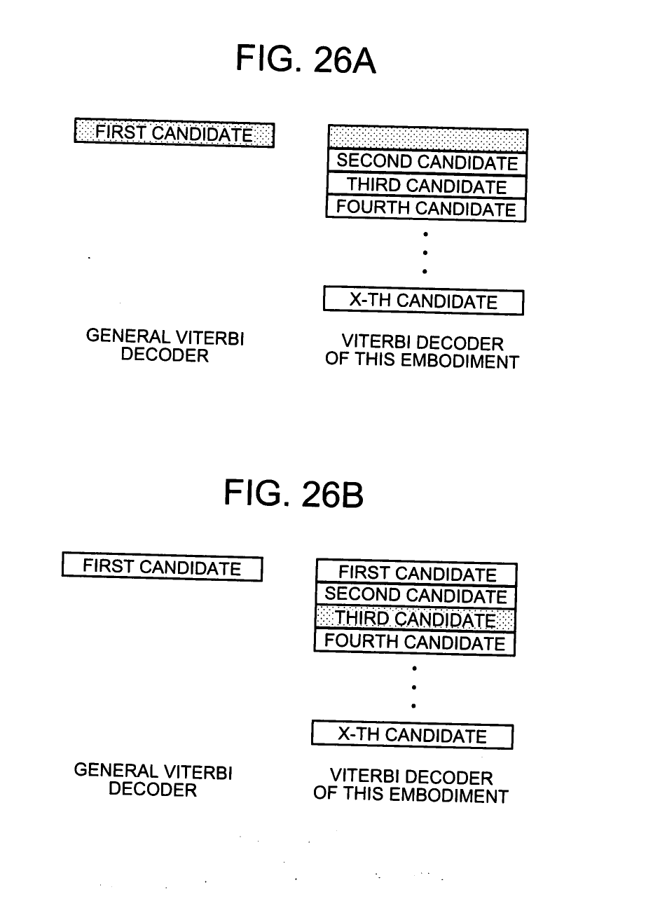

In the general Viterbi decoding device, in the case where the maximum likelihood reply is in error, the decoding is given up at that time point. However, in this embodiment, even in the case where the maximum likelihood reply is in error, it is possible to provide a second maximum likelihood reply by the second candidate. In the case where the second maximum likelihood reply is in error, a third maximum likelihood reply is provided by the third candidate. As described above, the provision of plural replies makes it possible to increase the possibility of correct answers (error correction performance) FIG. 26A shows the decoding results in the case where the noises are small. When the configurations other than the ACS result conversion section are identical, a reply of the first candidate is the same. In this case, when it is assumed that the first candidate is the correct answer, both of the decoding devices are successful in decoding.

FIG. 26B shows a decoding result in the case where the noises are large. In the case where a reply of the first candidate is in error, the general Viterbi decoding device gives up the decoding (error correction failure) whereas the decoding is continued to lead the correct answer by the third candidate in this example.

Subsequently, a reason that the upgrading of the error correction performance is larger as the data size is smaller will be described. The following two reasons are proposed.

First, the number of error data is smaller as the data size is smaller. That the data size is smaller means that the number of incorrect data is also smaller. For example, in the case of a pattern 1 bit is incorrect per 10 bits, 1 bit is incorrect when the data size is 10 bits, and 10 bits are incorrect when the data size is 100 bits although the fact is not as simple as this example. When even 1 bit is incorrect, the decoding fails, however, the decoding is successful when 1 bit is corrected in the former. Because the probability that 1 bit is corrected is higher than the probability that 10 bits are corrected, the probability that the decoding is conducted by applying the method according to this embodiment is higher as the data size is smaller.

Also, in the case where the data size is larger, even if a portion that is made incorrect by the first decoding is corrected by second or subsequent decoding, the possibility that other portions (originally correct portions) are newly made incorrect becomes high.

Second, as the data size is smaller, the error correction performance is lower. As described above, the likelihood information (input history) on the data that has been input before is also used in obtaining some data in the Viterbi decoding. The accumulated likelihood information is larger as the data volume is larger, and even when the error data is inputted at a certain time point, the possibility that the error data is corrected from the input history becomes high. In the case where the data volume is small, the input history is small with the result that the possibility that the error data is not corrected becomes higher. Accordingly, the error rate is smaller as the data size is larger to some degree. That is, since the correction performance is lower as the data size is smaller, the error is readily corrected by conducting the decoding by plural times.

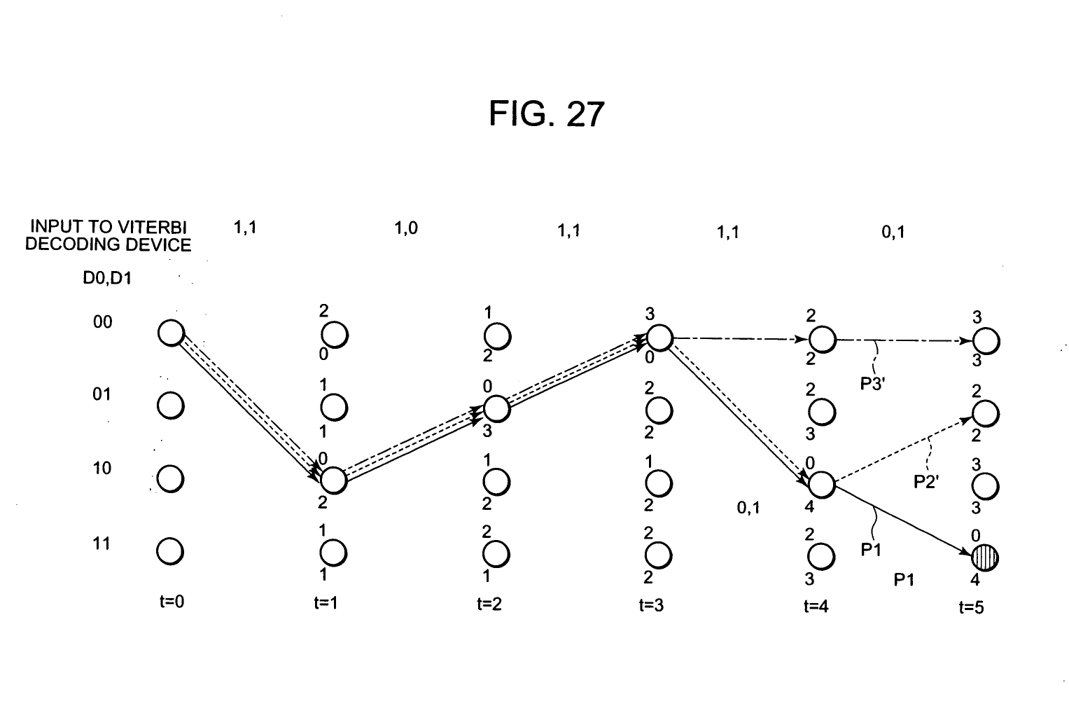

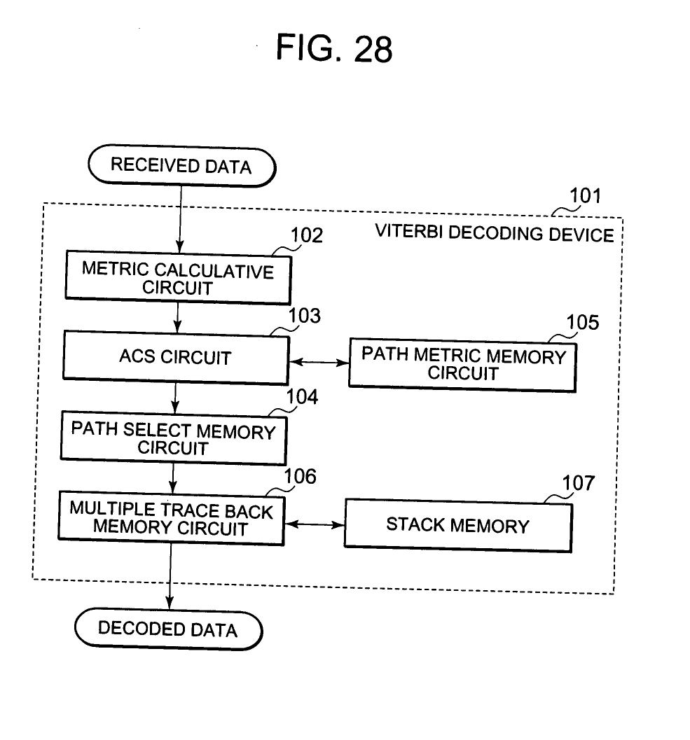

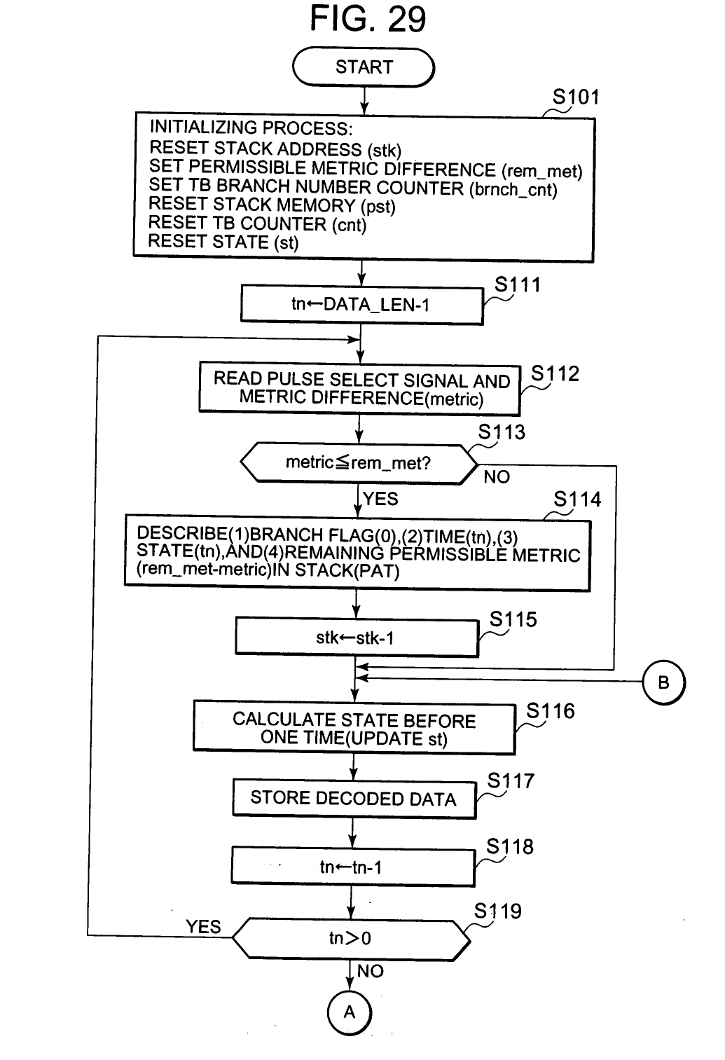

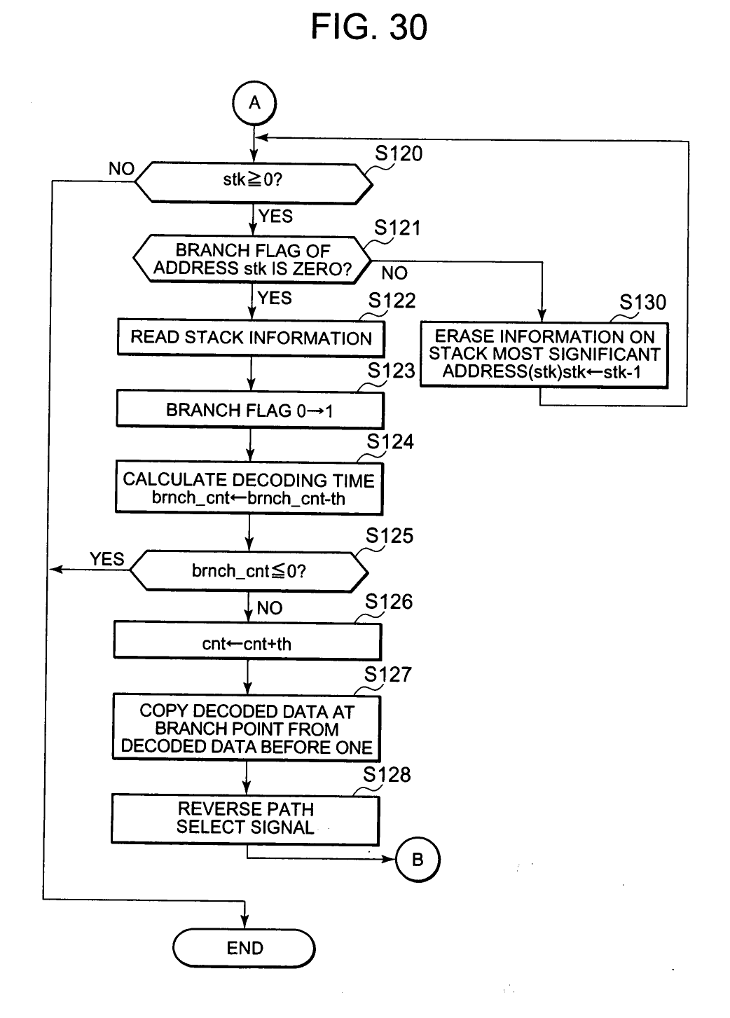

The present invention is not limit to only the above-mentioned embodiments. It will be obvious to those skilled in the art that various changes may be made without departing from the scope of the invention. For example, in the above embodiment, the second candidate uses the decoding path that is traced back as a branch different from the first candidate when only one branch is traced back from the state at the time of terminating the trellis. In the W-CDMA, because the tail bit is inserted, the state zero at the time of terminating the trellis is highest in the likelihood, and the state zero is selected as the final state. On the contrary, in the case where no tail bit is inserted, the state that is highest in the likelihood in the final state in the final state on the trellis diagram is not limited to the state zero. Accordingly, in this case, as shown in FIG. 27, the state that is highest in the likelihood in the final state is selected as the first candidate. Alternatively, in the case where the decoding path of the first candidate is in error, a decoding path P2′ that is traced back from the state that is second highest in the likelihood in the final state can be selected as the second candidate. The same is applicable to a decoding path P3′ of the third candidate. The decoding path can be traced back from the state that is third highest in the likelihood.

That is, in the case where an error is detected in the decoded data of the N-th decoding path, the (N+1)-th decoding path that is traced back from the state that is (N+1)-th highest in the likelihood is obtained in the final state. Then, redecoding is conducted by the (N+1)-th decoding path, to thereby enable the error correction performance to be improved.

Also, in the above embodiment, the configuration of hardware is described. However, the present invention is not limited to this configuration, arbitrary processing can be realized by allowing a CPU (central processing unit) to execute computer program. In this case, it is possible that the computer program is recorded on a recording medium and supplied. Also, the computer program can be supplied by transmitting the computer program through the Internet or another transmission medium.

It is apparent that the present invention is not limited to the above embodiments, but maybe modified and changed without departing from the scope and spirit of the invention.

What is claimed is:

1. A decoding method comprising:
obtaining a first decoded result from a first decoding path being on a trellis diagram;
determining whether the first decoded result is incorrect or not;
creating a second decoding path when the first decoded result is incorrect; and
obtaining a second decoded result from the second decoding path.

2. The decoding method according to claim 1, wherein
the first decoding path includes a first branch connecting a first state and a second state, the second state being at a time point previous to the first state and
the second decoding path includes a second branch connecting the first state and a third state, the third state being different from the second state and at a time point equal to the second state.

3. The decoding method according to claim 2, further comprising:
determining whether the second decoded result is incorrect or not;
creating a third decoding path when the second decoded result is incorrect; and
obtaining a third decoded result from the third decoding path.

4. The decoding method according to claim 3, wherein
the first decoding path further includes a third branch connecting the second state and a fourth state, the fourth state being at a time point previous to the second and third states and
the third decoding path includes the first branch and a fourth branch connecting the second state and a fifth state, the fifth state being different from the fourth state and at a time point equal to the fourth state.

5. The decoding method according to claim 4, wherein creating a new decoding path and obtaining a new decoded result are repeated till a correct decoded result is obtained.

6. The decoding method according to claim 4, wherein creating a new decoding path and obtaining a new decoded result are repeated predetermined number of times.

7. The decoding method according to claim 1, wherein the first decoding path has the highest likelihood in decoding paths being on the trellis diagram.

8. The decoding method according to claim 1, wherein the second decoding path has the second highest likelihood in the decoding paths.

9. The decoding method according to claim 2, wherein the first state is a final state being at a final time point of the trellis diagram.

10. The decoding method according to claim 1, wherein the first decoded result is obtained by performing a trace back on the trellis diagram.
